(19) United States
(12) Patent Application Publication
(10) Pub. No.: US 2017/0016274 A1
(43) Pub. Date: Jan. 19, 2017

(54) WINDOW BLIND ASSEMBLY

(71) Applicant: Supreme Plastic Products Co., Ltd., Guangdong (CN)

(72) Inventor: SONG-LI ZHENG, Guangdong (CN)

(21) Appl. No.: 14/801,768

(22) Filed: Jul. 16, 2015

(51) Int. Cl. E06B 9/322; E06B 9/26

(52) U.S. Cl. CPC E06B 9/322; E06B 9/26; E06B 2009/3227

(57) ABSTRACT

A window blind assembly is disclosed and comprises a blind set, a light modulation device, a pull cord take-up device, and a coil spring control device. The blind set includes a bottom rail, a stopper, leaves, a blind ladder, pull cords, and a headrail. The light modulation device includes a wheel set, a wheel, a cover, an iron bar, a block, and a stick. The pull cord take-up device includes two mounts, a wrapping reel, and iron cores. The coil spring control device includes a bottom plate, a driving gear, a spring shaft, a coil spring, an upper gear cap, an upper cap, and a driven gear. The angle adjustment of the leaves of the blind set is realized by rotating the wrapping reel. When the bottom rail is pulled downwardly, the pull cords are driving the wrapping reel to rotate. The pull cord arranged on the coil spring control device is pulled out and wrapped around the wrapping reel. When the bottom rail is pulled upwardly, the pull cords is taken up in the coil spring control device and wrapped around the wrapping reel. It has the advantages of simplified structure, safety, and reliability, especially suitable for using in house.

### FIELD OF THE INVENTION

The present invention relates to a window blind assembly, and more particularly to a 50 mm window blind assembly with hidden cord.

### BACKGROUND OF THE INVENTION

The conventional window blind assembly is raised and lowered by hand with a pull cord, and the leaves are rotated by an exposed pull cord or rotating bar. The pull cord is knotted easily after being used for a long time and then the knotted pull cord is hard to release and inconvenient to the users. Consequently, it may be not safe for the children who are staying the house. The dangers are often happened, even the safety marks and the warning signs are hanged on the pull cord.

Accordingly, the inventor of the present invention has devoted himself based on his many years of practical experiences to solve this problem.

### SUMMARY OF THE INVENTION

The primary object of the present invention is to provide a window blind assembly. The window blind assembly comprises a blind set, a light modulation device, a pull cord take-up device, and a coil spring control device. The blind set includes a bottom rail, a stopper, leaves, a blind ladder, a pull cord, and headrail. The light modulation device includes a wheel set, a wheel, a cover, an iron bar, a block, and a stick. The wheel set is stuck in a groove hole of the headrail. The wheel is arranged on the wheel set. The cover is stuck in the wheel set and covered the wheel. The blind ladder is hanged on the wheel. The leaves are passing through squares of the blind ladder respectively. The bottom rail is passing through the lowest square of the blind ladder. The block is installed in a groove of the headrail. The stick is hanged on the block. The iron bar is passing from a block hole of the block to a wheel hole of the wheel. The pull cord take-up device includes two mounts, a wrapping reel, rivets, and iron cores. The mounts are fastened in the headrail by the rivets. The iron cores are mounted on the mounts. The coil spring control device includes a bottom plate, a driving gear, a spring shaft, a coil spring, an upper gear cap, an upper cap, and a driven gear. The coil spring take-up device is fastened to a fattener by screws. The coil spring is mounted on a coil-spring shaft and then installed into the driving gear. The upper gear cap is covered on the driving gear. A head of the coil spring is stuck on the driven gear. The driving gear is engaged with the driven gear and then installed into a core of the bottom plate. The upper cap is fastened on the bottom plate by screws. The coil spring control device is installed in the headrail and fastened by the fastener. The assembly is characterized in that the pull cord take-up device has three pull cords. Two thereof are passing through the wheel set, laves, and the bottom rail and then fastened on the bottom rail, and the stopper is fastened on the bottom rail. One thereof is connected to the coil spring control device and wrapped around the driving gear or driven gear.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a perspective view of a window blind assembly according to present invention.

FIG. 2 is a plan view of the window blind assembly according to present invention.

FIG. 3 is an exploded view of a coil spring control device of the window blind assembly according to present invention.

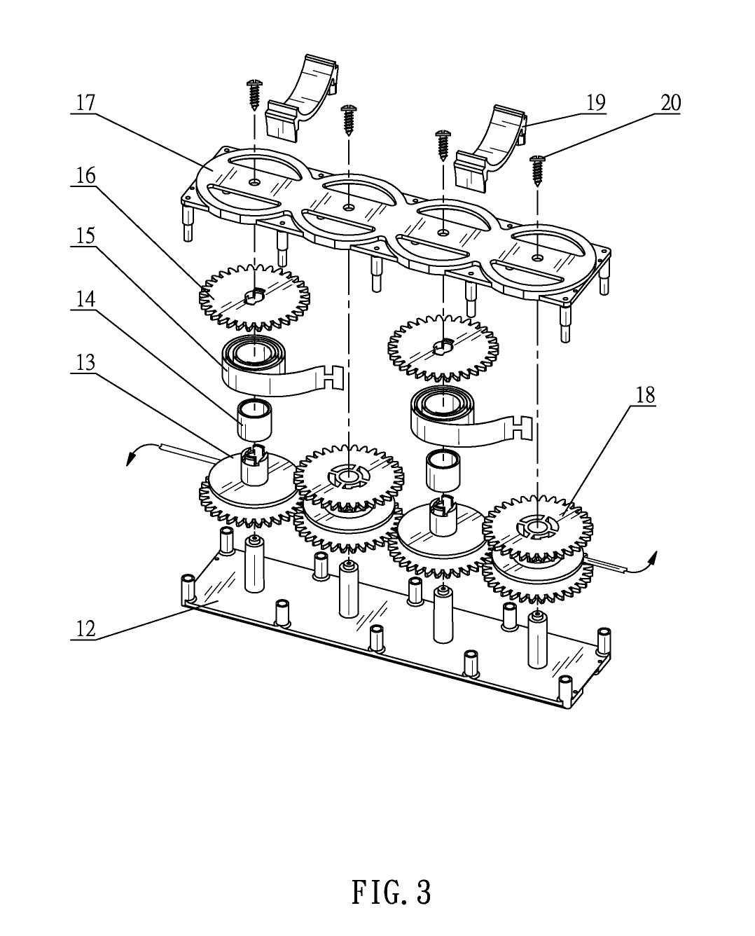

FIG. 4 is an exploded view of a light modulation device of the window blind assembly according to present invention.

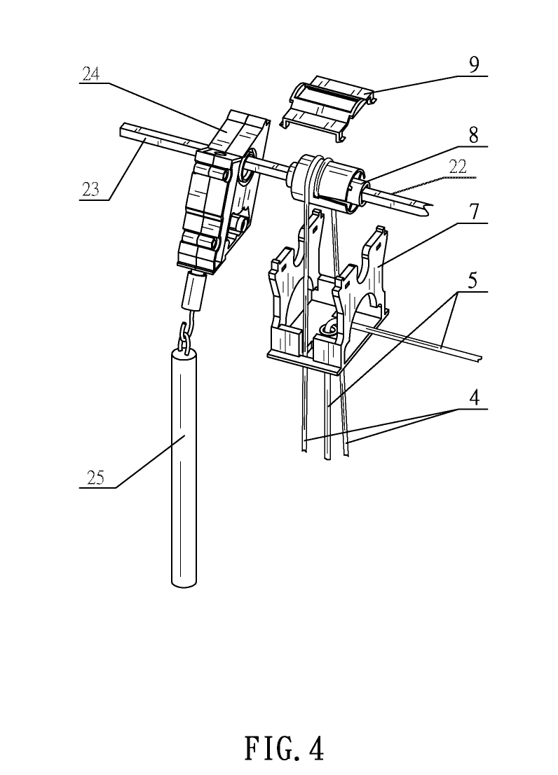

FIG. 5 is an exploded view of a pull cord take-up device of the window blind assembly according to present invention.

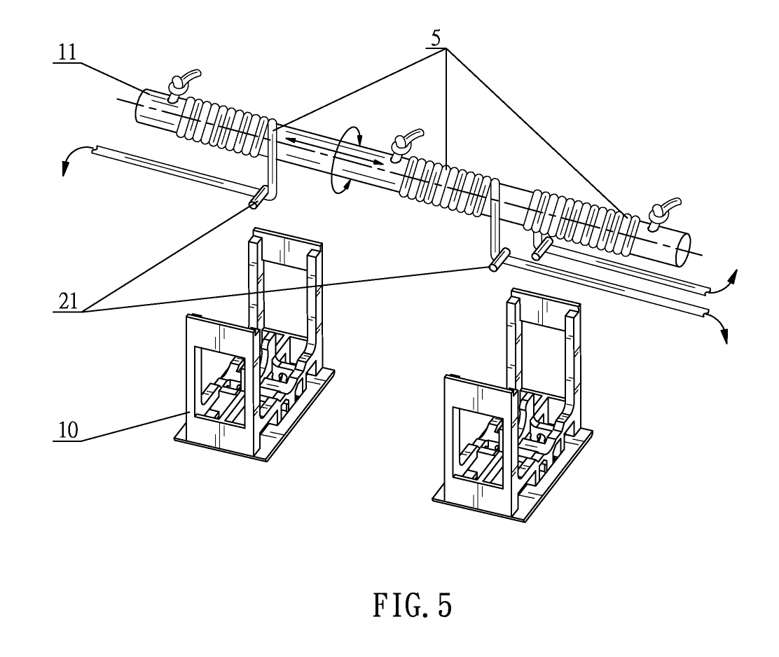

### DESCRIPTION OF THE PREFERRED EMBODIMENT

Referring now to the drawings where like characteristics and features among the various figures are denoted by like reference characters.

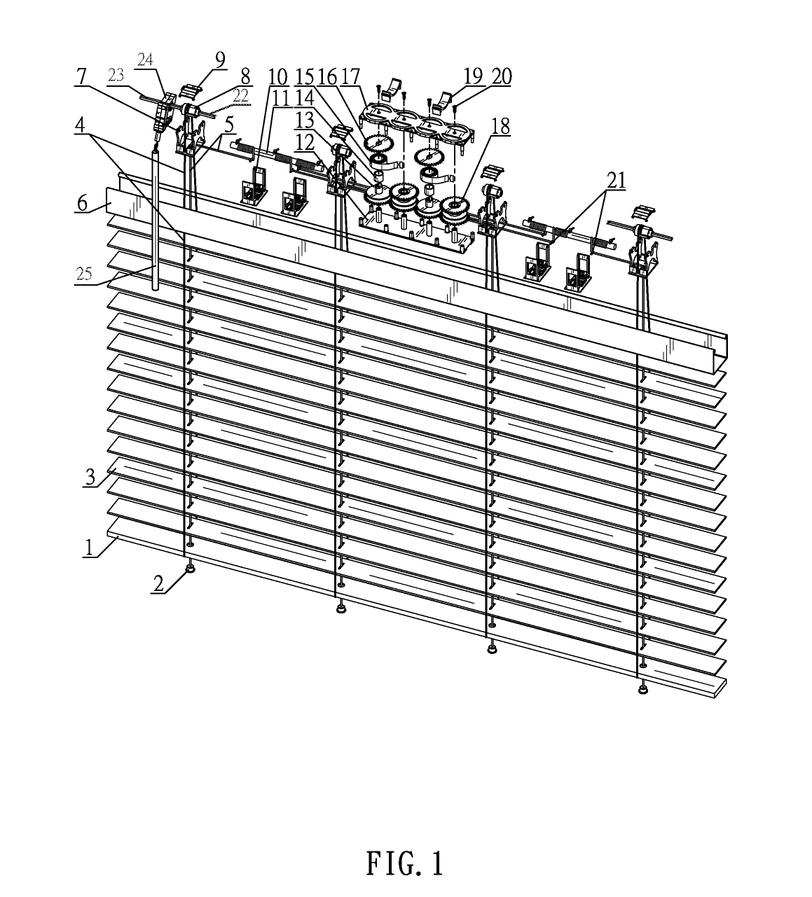

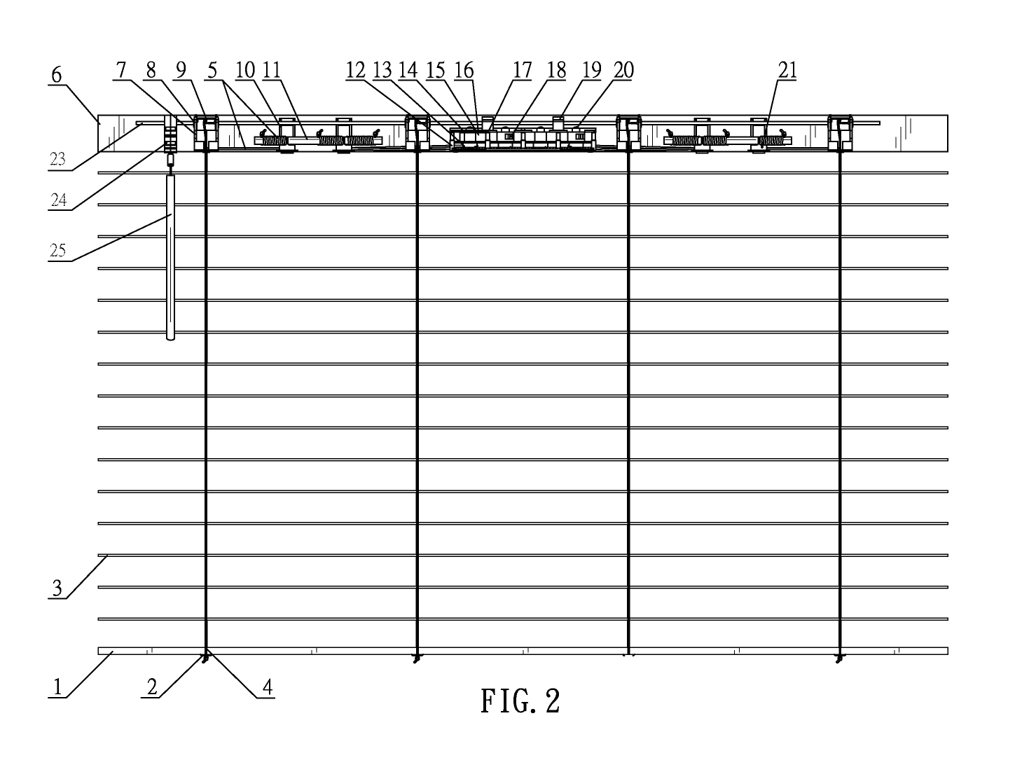

FIG. 1 is a perspective view of a window blind assembly according to present invention. FIG. 2 is a plan view of the window blind assembly according to present invention. The window blind assembly of this invention comprises a blind set, a light modulation device, a pull cord take-up device, and a coil spring control device. The pull cord take-up device is fastened to a headrail of the blind set by a fastener and the coil spring control device is fastened to the headrail by a fastener. They are connected with one another by pull cords to realize the raising and lowering the blind set and light modulation.

The structures of the blind set and the light modulation device are described as follows. The blind set may include a bottom rail 1, a stopper 2, leaves 3, a blind ladder 4, pull cords 5, and a headrail 6. The light modulation device may include a wheel set 7, a wheel 8, a cover 9, an iron bar 23, a block 24, and a stick 25. The wheel set 7 is stuck in a groove hole of the headrail 6. The wheel 8 is arranged on the wheel set 7. The cover 9 is stuck on the wheel set 7 and covered the wheel 8. The blind ladder 4 is hanged on the wheel 8. The leaves 3 are passing through squares of the blind ladder 4 respectively. The bottom rail 1 is passing through the lowest square of the blind ladder 4. The block 24 is installed in a groove of the headrail 6. The stick 25 is hanged on the block 24. The iron bar 23 is passing from a block hole of the block 24 to a wheel hole of the wheel 8. In addition, the wheel, the wheel set, the cover, and blind ladder are a set of mechanism. The amount of the set of mechanism is changeably according to the width of the blind set.

The pull cord take-up device is described as follows. The pull cord take-up device includes two mounts 10, a wrapping reel 11, and iron cores 22. The mounts are fastened in the headrail 6 by the rivets 21. The wrapping wheel 11 is freely rotatably and axially movably installed in the mounts 10. Three pull cords are wrapped around the wrapping reel 11. One of the pull cords is connected to the driving gear 13 or the driven gear 18 of the coil spring control device. Another two of the pull cords are passing through the wheel set 7, the headrail 6, leaves 3, the bottom rail 1, and a hole of the stopper 2, and then tied. The stopper 2 is fastened at the bottom rail 1. The pull cord on the wrapping reel connected to the stopper 2 and the pull cord on the wrapping reel connected to the coil spring control device must be wrapped around the iron cores 22 of corresponding mounts 10. The wrapping directions of the pull cord on the wrapping reel connected to the stopper 2 and the pull cord on the wrapping reel connected to the coil spring control device are opposite. The amount of the pull cord take-up device is changeable according to the size of the blind set.

The coil spring control device is described as follows. The coil spring control device may include a bottom plate 12, a driving gear 13, a spring shaft 14, a coil spring 15, an upper gear cap 16, an upper cap 17, and a driven gear 18.

The coil spring take-up device is fastened in the head rail 6 by a fastener 19 (such as screws 20). The coil spring 15 is mounted on the spring shaft 14 and then installed into the driving gear 13. The upper gear cap 16 is covered on the driving gear 13. A head of the coil spring 15 is stuck on the driven gear 18. The driving gear 13 is engaged with the driven gear 18 and then installed into a core of the bottom plate 12. The upper cap 17 is fastened on the bottom plate 12 by screws 20. The coil spring control device is installed in the headrail 6 and fastened by the fastener 19. The amount of the coil spring take-up device is changeably according to the size of the blind set.

When in use, the wrapping reel 11 is rotated to drive the rotation of the iron bar 23 by the principle of worms and worm gears. The iron bar 23 is driving the wheel 8 to rotate. The wheel 8 is driving the front side of the blind ladder 4 to raise and the rear side of the blind ladder 4 to lower, or the front side of the blind ladder 4 to lower and the rear side of the blind side of the blind ladder 4 to raise. The leaves 3 passing through the squares of the blind ladder 4 are turned over with the blind ladder 4. It may realize the effect of light modulation. When the blind set is lowered, the bottom rail 1 is pulled downwardly by hand to lower the blind set and the force on the pull cord is driving the wrapping reel 11 to rotate to release the pull cord loop by loop. Simultaneously, the pull cord connected to the coil spring control device is pulled out and then wrapped around the wrapping reel 11. And the driving gear 13 is driven thereby. The driving gear 13 is driving the driven gear 18 to rotate through the engagement of the driving gear 13 and the driven gear 18. The coil spring 15 fastened to the driving gear 13 is wrapped around the driven gear 18 loop by loop. The coil spring 15 is tensioned. The pull cords fastened on each gear are synchronously wrapped around corresponding wrapping reel 11 due to the engagement of the gears. The blind set may be lowered smoothly. Till the hand stops to force, the blind set may keep at the position due to the force balance among the weight of the blind set, the friction of each contact, and the elastic force of the coil spring 15. When the blind set is raised, the bottom rail 1 of the blind set is pulled upwardly and the force balance is upset. The pull cords are not forced and the force exerted on the driving gear 13 is decreased and the driving gear 13 is rotated in revered direction compared to the original direction. The coil spring 15 starts to release and is wrapped around the driving gear 13 again. The pull cords wrapped on the driving gear 13 may be taken up in a cord groove of the driving gear 13. Simultaneously, the pull cord connected to the stopper 2 and arranged on the wrapping reel 11 is synchronously taken up on the wrapping reel 11. The pull cords fastened on each gear are synchronously taken up in corresponding cord grooves due to the engagement of all gears. Smoothly raising the blind set may be realized.

Therefore, the raising and lowering of the blind set at will may be achieved by the force exerted on the bottom rail of the blind set through the pull cords to drive the pull cord take-up device and the coil spring control device by hand. The light modulation may be achieved by the light modulation device. The blind set may be raised and lowered at any position at will in the status with exposed pull cords. It has the advantages of simplified structure, stable transmission and drive, low cost, safety, and reliability. It is especially suitable for using in house and office.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

1. A window blind assembly, comprising a blind set, a light modulation device, a pull cord take-up device, and a coil spring control device, wherein the pull cord take-up device includes two mounts, a wrapping reel, and a plurality of iron cores. the mounts are fastened in a headrail of the blind set by a plurality of rivets, the wrapping wheel is freely rotatably and axially movably installed in the mounts;
wherein three pull cords are wrapped around the wrapping reel, one of the pull cords is connected to a driving gear or a driven gear of the coil spring control device and another two of the pull cords are passed through the wheel set, the headrail, leaves of the blind set, a bottom rail of the blind set, and a hole of the stopper of the blind set and then tied;
wherein the stopper is fastened to the bottom rail, the pull cord on the wrapping reel connected to the stopper and the pull cord on the wrapping reel connected to the coil spring control device are wrapped around the iron cores of the corresponding mounts, the wrapping directions of the pull cord on the wrapping reel connected to the stopper and the pull cord on the wrapping reel connected to the coil spring control device are opposite; and
wherein the amount of the pull cord take-up device is changeable according to the size of the blind set.
